(19) United States
(12) Patent Application Publication
(10) Pub. No.: US 2026/0336505 A1
(43) Pub. Date: Oct. 29, 2026

(54) EDGE PROTECTOR

(71) Applicant: Cargo Stop International Ltd, Colchester (GB)

(72) Inventor: Oliver Barber, Colchester, Essex (GB)

(21) Appl. No.: 19/115,185

(22) PCT Filed: Sep. 8, 2023
(86) PCT No.: PCT/GB2023/052337

§ 371 Date: Mar. 25, 2025

(30) Foreign Application Priority Data
Sep. 27, 2022 (GB) 2214064.4

(51) Int. Cl. B60P 7/08; B65D 81/05

(52) U.S. Cl. CPC B60P 7/0869; B65D 81/054

(57) ABSTRACT

An edge protector protects an edge of a load when secured with tethering straps. The edge protector comprises a first plate and a second plate for respectively contacting first and second surfaces of the load. The edge protector further comprises a first wall structure and a second wall structure for retaining a pair of crosswise tethering straps laterally on the edge protector.

### RELATED APPLICATIONS

The present application is a U.S. National Stage under 35 U.S.C. § 371 of International Application No. PCT/GB2023/052337 filed on Sep. 8, 2023, which claims priority to Great Britain Application No. 2214064.4 filed on Sep. 27, 2022, and having inventors in common, which are incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present invention relates to an edge protector for protecting an edge of a load when secured with tethering straps.

### BACKGROUND

Edge protectors are often used to protect the edges of loads when secured to platforms, such as vehicle or trailer platforms. Typically, a pair of edge protectors are positioned on opposite sides of the load, with a first plate of each edge protector contacting a vertical side face of the load and a perpendicular second plate of the edge protector contacting a horizontal top face of the load. A tethering strap, such as a webbing strap, is then attached at one side of the platform, passed up and over the first edge protector, passed across the load, passed over and down the second edge protector, and then attached at the opposite side of the platform so as to secure the load. The tethering strap may then be tightened, for example with a ratchet. The edge protectors accordingly protect the edges of the load from being damaged by the downward restraining force exerted by the tethering strap. Conventional edge protectors tend only to be reliable when the tethering strap passes vertically straight up and then passes perpendicularly over the load. However, this can mean that the tethering straps are only able to substantially retain the load in the vertical direction, and such arrangements must rely on friction to prevent the load from shifting horizontally. This can be an issue when trying to secure loads consisting of plural stacked objects, such as bricks or blocks, which tend to shift horizontally relative to one another under braking or when turning a vehicle. It is therefore desired to provide improved edge protectors.

### BRIEF OVERVIEW

According to an aspect of the present invention there is provided an edge protector for protecting an edge of a load when secured with tethering straps, the edge protector comprising: first and second plates for respectively contacting first and second surfaces of a load; and first and second wall structures for retaining a pair of crosswise tethering straps laterally on the edge protector.

According to another aspect of the present invention there is provided a method of securing a load with tethering straps, the method comprising: placing an edge protector on an edge of the load, wherein first and second plates of the edge protector respectively contact first and second surfaces of the load; and placing a pair of crosswise tethering straps on the edge protector, wherein the pair of crosswise tethering straps are retained laterally on the edge protector by first and second wall structures of the edge protector.

As will be appreciated, embodiments of the present invention can allow an edge protector to be used in conjunction with a pair of crosswise tethering straps. When tightened to secure the load, those crosswise tethering straps can provide an increased horizontal component of restraining force. Furthermore, by providing first and second wall structures on the edge protector, the tethering straps can be prevented from slipping laterally off the edge protector. This can allow a load to be secured in a more reliable manner. For example, two or more such edge protectors may be provided on adjacent (rather than opposite) vertical sides of a load, with a tethering strap running diagonally up one side of the load, diagonally across the top surface of the load, and then diagonally down the adjacent side of the load.

In embodiments, the first plate may be substantially perpendicular to the second plate. These embodiments can allow the edge protector to be used with a cuboid load. The load may comprise plural (e.g. cuboid) stacked objects, such as bricks or blocks. The second plate may be larger and/or heavier than the first plate. These embodiments can allow the second plate to be counterbalanced on a top surface of a load, prior to the crosswise tethering straps being provided thereon, without the edge protector tipping off the load. This can in turn help with the process of holding the edge protector in place whilst securing the load.

In embodiments, the first and second wall structures may have inward parts which are closer to one another (e.g. at or towards the crossing point of the crosswise tethering straps) and outward parts which are further from one another (e.g. away from the crossing point of the crosswise tethering straps). The first and second wall structures may each comprise a first wall portion provided on the first plate and/or a second wall portion provided on the second plate. The first wall portions of the first and second wall structures may extend outwardly away from one another. Similarly, the second wall portions of the first and second wall structures may extend outwardly away from one another. These embodiments can further help to maintain the tethering straps in crosswise orientation on the edge protector.

In embodiments, the first and second plates may each have an inner width which is narrower (e.g. at or towards the crossing point of the crosswise tethering straps) and an outer width which is wider (e.g. away from the crossing point of the crosswise tethering straps). These embodiments can help to reduce the amount of material needed to form the edge protector whilst still providing first and second plates with a large surface area to distribute restraining force.

In embodiments, the edge protector may comprise one or more projecting structures, such as first and second projecting structures, for receiving and retaining a tethering strap thereunder. The first and second projecting structures may project inwardly towards one another. The first and second projecting structures may be spaced apart to allow the pair of crosswise tethering straps to be inserted therebetween. The one or more projecting structures may comprise tabs or fingers. These embodiments can, for example, help to retain the crosswise tethering straps on the edge protector. The one or more projecting structures may project from the second plate, for example so as to provide additional weight thereto, rather than from the first plate.

In embodiments, the first and second plates may be joined at an interface. The interface between the first and second plates may comprise a channel which is configured not to contact the load. These embodiments can further help to protect the edge of the load from damage caused by the restraining force.

In embodiments, the edge protector may be of unitary construction. The edge protector may be formed of polymeric (e.g. moulded) material. These embodiments can help to provide an edge protector which is robust, lightweight, and easy to manufacture.

In embodiments, the method may comprise attaching one or more ends of the crosswise tethering straps to a platform, such as a vehicle or trailer platform. The method may further comprise operating one or more ratchets for the crosswise tethering straps to tighten the crosswise tethering straps. As will be appreciated, the method may be performed in respect of plural edge protectors and/or plural pairs of tethering straps. The plural edge protectors may be provided on adjacent (rather than opposite) sides of the load, with a tethering strap running diagonally up a side of the load, diagonally across a top surface of the load, and then diagonally down an adjacent side of the load.

### BRIEF DESCRIPTION OF THE DRAWINGS

By way of example only, embodiments of the invention will now be described in detail with reference being made to the accompanying drawings in which:

FIG. 1 is a first perspective view of an edge protector according to an embodiment of the present invention;

FIG. 2 is a second perspective view of the edge protector of FIG. 1;

FIG. 3 is a top view of the edge protector of FIG. 1 together with tethering straps;

FIG. 4 is a side view of the edge protector of FIG. 1 when positioned on an edge of a load; and

FIG. 5 is a rear view of the edge protector of FIG. 1 together with tethering straps.

### DETAILED DESCRIPTION

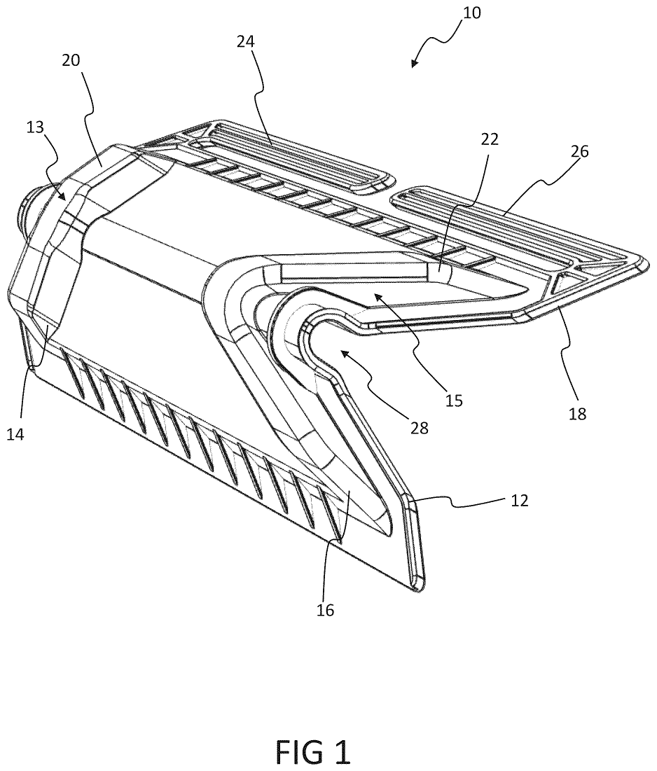

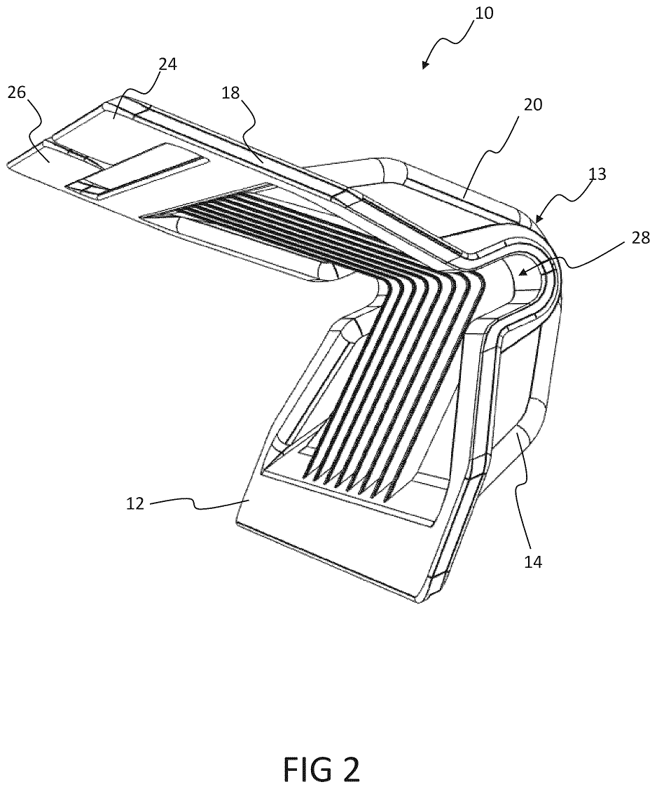

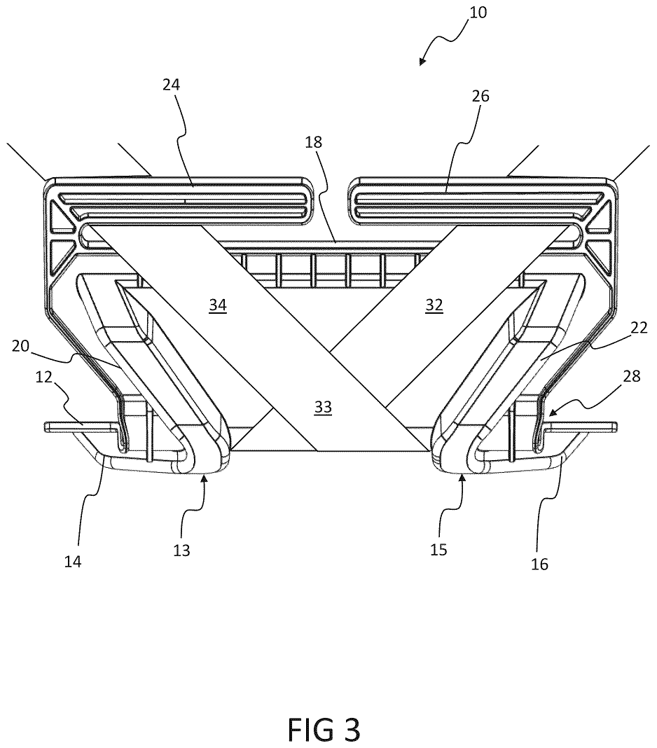

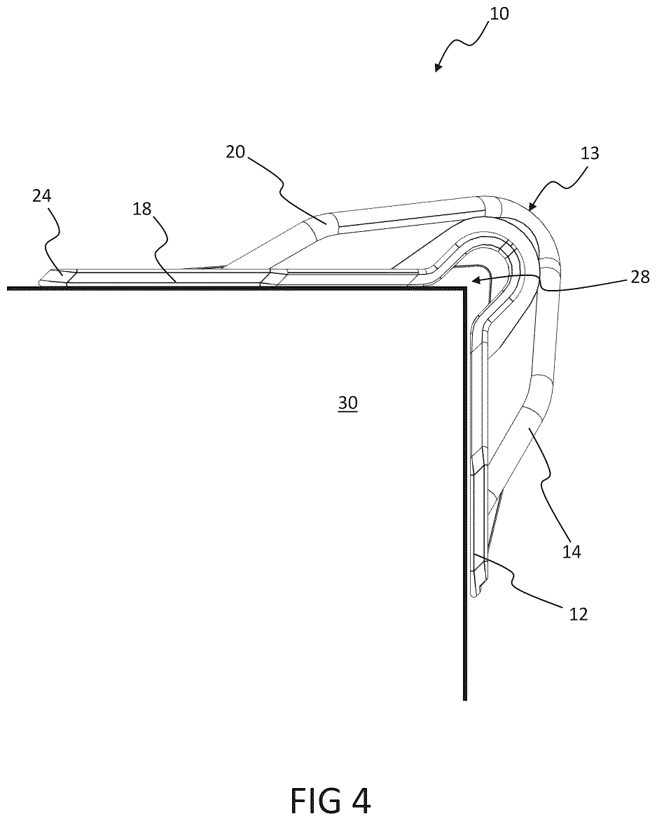

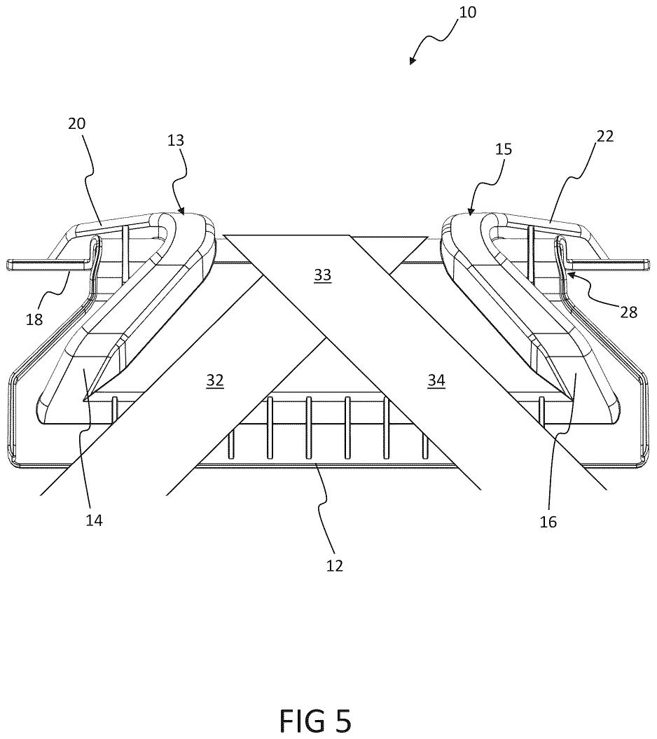

FIGS. 1-5 show an edge protector 10 for protecting an edge of a cuboid load 30 when secured with crosswise tethering straps 32, 34, such as webbing straps. In this embodiment, the edge protector 10 is of unitary construction and is formed of moulded polymeric material. The edge protector 10 comprises a first plate 12 for contacting a vertical surface of the load 30. The edge protector 10 further comprises a second plate 18, extending perpendicular to the first plate 12, for contacting a horizontal surface of the load 30. The second plate 18 is slightly larger and heavier than the first plate 12 to help to counterbalance the edge protector 10 and thereby prevent the edge protector 10 from tipping off the load 30 in the absence of the tethering straps 32, 34. The edge protector 10 further comprises a first wall structure 13 having a first wall portion 14 on the first plate 12 and a second wall portion 20 on the second plate 18. The edge protector 10 further comprises a second wall structure 15 also having a first wall portion 16 on the first plate 12 and a second wall portion 22 on the second plate 18. As can best be seen in FIGS. 3 and 5, the first and second wall structures 13, 15 have inward parts (central regions) which are closer to one another at the crossing point 33 of the crosswise tethering straps 32, 34 and outward parts (distal ends) which are further from one another, with the first wall portions 14, 16 extending outwardly away from one another and with the second wall portions 20, 22 also extending outwardly away from one another. The first and second plates 12, 18 also each correspondingly have an inner (central) width which is narrower and an outer (distal) width which is wider. The first and second wall structures 13, 15 accordingly act to retain the pair of tethering straps 32, 34 laterally on the edge protector 10 in a crosswise configuration. The edge protector 10 also has first and second projecting structures 24, 26 in the form of tabs or fingers that project from the second plate 18 inwardly towards one another. The first and second projecting structures 24, 26 receive the tethering straps 32, 34 when inserted therebetween and then retain the tethering straps 32, 34 thereunder. The interface between the first and second plates 12, 18 also comprises a channel 28 which is configured not to contact the edge of the load 30, and thereby further protects the edge of the load 30. In use, in order to fully secure the load 30, the ends (not shown) of the crosswise tethering straps 32, 34 are attached to a platform (also not shown), such as a vehicle or trailer platform, and ratchets (also not shown) for the crosswise tethering straps 32, 34 are operated to tighten those straps. The crosswise tethering straps 32, 34 accordingly provide an increased horizontal component of restraining force when compared with a single tethering strap.

1. An edge protector for protecting an edge of a load when secured with tethering straps, the edge protector comprising:
first and second plates for respectively contacting first and second surfaces of a load; and
first and second wall structures for retaining a pair of crosswise tethering straps laterally on the edge protector.

2. An edge protector as claimed in claim 1, wherein the first plate is substantially perpendicular to the second plate.

3. An edge protector as claimed in claim 1, wherein the second plate is at least one of larger and heavier than the first plate.

4. An edge protector as claimed in claim 1, wherein the first and second wall structures have inward parts which are closer to one another and outward parts which are further from one another.

5. An edge protector as claimed claim 1, wherein the first and second wall structures each comprise a first wall portion provided on the first plate and a second wall portion provided on the second plate.

6. An edge protector as claimed in claim 1, wherein the first and second plates each have an inner width which is narrower and an outer width which is wider.

7. An edge protector as claimed in claim 1, wherein the edge protector comprises first and second projecting structures for receiving and retaining a tethering strap thereunder.

8. An edge protector as claimed in claim 7, wherein the first and second projecting structures project inwardly towards one another.

9. An edge protector as claimed in claim 7, wherein the first and second projecting structures comprise tabs or fingers.

10. An edge protector as claimed in claim 7, wherein the first and second projecting structures are spaced apart to allow the pair of crosswise tethering straps to be inserted therebetween.

11. An edge protector as claimed in claim in claim 7, wherein the first and second projecting structures project from the second plate.

12. An edge protector as claimed in claim 1, wherein an interface between the first and second plates comprises a channel which is configured not to contact the load.

13. An edge protector as claimed in claim 1, wherein the edge protector is of unitary construction.

14. An edge protector as claimed in claim 1, wherein the edge protector is formed of polymeric material.

15. A method of securing a load with tethering straps, the method comprising:
placing an edge protector on an edge of the load, wherein first and second plates of the edge protector respectively contact first and second surfaces of the load; and
placing a pair of crosswise tethering straps on the edge protector, wherein the pair of crosswise tethering straps are retained laterally on the edge protector by first and second wall structures of the edge protector.
